(19) United States
(12) Patent Application Publication
(10) Pub. No.: US 2006/0280395 A1
(43) Pub. Date: Dec. 14, 2006

(54) CONTROL OF TE AND TM MODES IN ELECTROOPTIC WAVEGUIDE DEVICES

(75) Inventors: Steven M. Risser, Reynoldsburg, OH (US); Richard W. Ridgway, Westerville, OH (US); David W. Nippa, Dublin, OH (US); Richard Joseph Higgins, Westerville, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: OPTIMER PHOTONICS, INC., Columbus, OH (US)

(21) Appl. No.: 11/456,346

(22) Filed: Jul. 10, 2006

Related U.S. Application Data
(63) Continuation of application No. PCT/US05/40243, filed on Nov. 4, 2005.
(60) Provisional application No. 60/625,036, filed on Nov. 4, 2004.
(60) Provisional application No. 60/630,652, filed on Nov. 23, 2004.
(60) Provisional application No. 60/666,870, filed on Mar. 31, 2005.
(60) Provisional application No. 60/644,768, filed on Jan. 18, 2005.
(60) Provisional application No. 60/718,359, filed on Sep. 19, 2005.

(51) Int. Cl. G02F 1/035

(52) U.S. Cl. 385/2; 385/40

(57) ABSTRACT

An optical waveguide structure is provided wherein a controller is configured to provide a TE control voltage to a first set of control electrodes in a first electrooptic functional region and a TM control voltage to a second set of control electrodes in a second electrooptic functional region. The TE control voltage and the first electrooptic functional region are configured to alter the TE polarization mode of an optical signal propagating along the waveguide core through the first electrooptic functional region to a substantially greater extent than the TM polarization mode of the optical signal. Further, the TM control voltage and the second electrooptic functional region are configured to alter the TM polarization mode of an optical signal propagating along the waveguide core through the second electrooptic functional region to a substantially greater extent than the TE polarization mode of the optical signal. Additional embodiments and features are disclosed and claimed.

### CROSS-REFERENCE TO RELATED APPLICATIONS

The present application is filed under 35 U.S.C. 111(a) as a continuation of international patent application no. PCT/US2005/040243 (OPI 0017 PB), field Nov. 4, 2005, which international application designates the United States and claims the benefit of U.S. Provisional Application Ser. Nos.: 60/625,036 (OPI 0017 MA), filed Nov. 4, 2004; 60/630,652 (OPI 0018 MA), filed Nov. 23, 2004; 60/666,870 (OPI 0018 M2), filed Mar. 31, 2005; 60/644,768 (OPI 0020 MA), filed Jan. 18, 2005; and 60/718,359 (OPI 0025 MA), filed Sep. 19, 2005.

### BACKGROUND OF THE INVENTION

The present invention relates to the control of optical signals traveling in a waveguide structure and, more particularly, to optical waveguide structures comprising two or more electrooptic functional regions configured for control of TE and TM polarization modes of optical signals propagating therein.

### BRIEF SUMMARY OF THE INVENTION

According to one embodiment of the present invention, an optical waveguide structure is provided comprising a waveguide core, first and second electrooptic functional regions, and a controller. The first electrooptic functional region comprises a first set of control electrodes, a cladding region, and an electrooptic region. The second electrooptic functional region comprises a second set of control electrodes, a cladding region, and an electrooptic region. The controller is configured to provide a TE control voltage to the first set of control electrodes and a TM control voltage to the second set of control electrodes. The TE control voltage is provided independent of the TM control voltage. The TE control voltage and the first electrooptic functional region are configured to alter the TE polarization mode of an optical signal to a substantially greater extent than the TM polarization mode of the optical signal while the TM control voltage and the second electrooptic functional region are configured to alter the TM polarization mode of the optical signal to a substantially greater extent than the TE polarization mode of the optical signal.

In accordance with another embodiment of the present invention, an optical waveguide structure is provided comprising first, second, and third electrooptic functional regions, and a controller. The third electrooptic functional region is defined between the first and second electrooptic functional regions and the controller is configured to provide a first control voltage to the first electrooptic functional region, a second control voltage to the second electrooptic functional region, and a polarization control voltage to the third electrooptic functional region. The first and second control voltages and the first and second electrooptic functional regions are configured to alter similarly oriented polarization modes of an optical signal propagating along the waveguide core while the polarization control voltage and the third electrooptic functional region are configured to reverse the respective magnitudes of TE and TM polarization modes of an optical signal propagating along the waveguide.

In accordance with additional embodiments of the present invention, a variety of novel electrode configurations are provided for treating particular modes of polarization of an optical signal propagating along a waveguide core.

Accordingly, it is an object of the present invention to provide for improved waveguide structures. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIGS. 1A and 2A are schematic illustrations of a first type of electrooptic region provided with a TE control voltage according to one embodiment of the present invention;

FIG. 1B and 2B are schematic illustrations of a second type of electrooptic region provided with a TM control voltage according to one embodiment of the present invention;

FIG. 3 is a schematic illustration of an optical waveguide structure including first and second electrooptic functional regions according to one embodiment of the present invention;

FIGS. 4 and 5 are schematic illustrations of additional electrooptic functional regions provided with TE control voltages according to the present invention;

FIG. 6 is a schematic illustration of an electrooptic functional regions including an extended upper electrode according to the present invention;

FIGS. 7 and 8 are schematic illustrations of additional electrooptic functional regions provided with TM control voltages according to the present invention;

FIG. 9 is a schematic illustration of an optical waveguide device according to one embodiment of the present invention employing an anti-recoupling region;

FIGS. 10-14, illustrate an alternative means for configuring an electrooptic functional region to treat the TE and TM polarization modes of an optical signal according to the present invention; and

FIGS. 15-17 illustrate an optical waveguide device incorporating a polarization control region according to the present invention.

### DETAILED DESCRIPTION

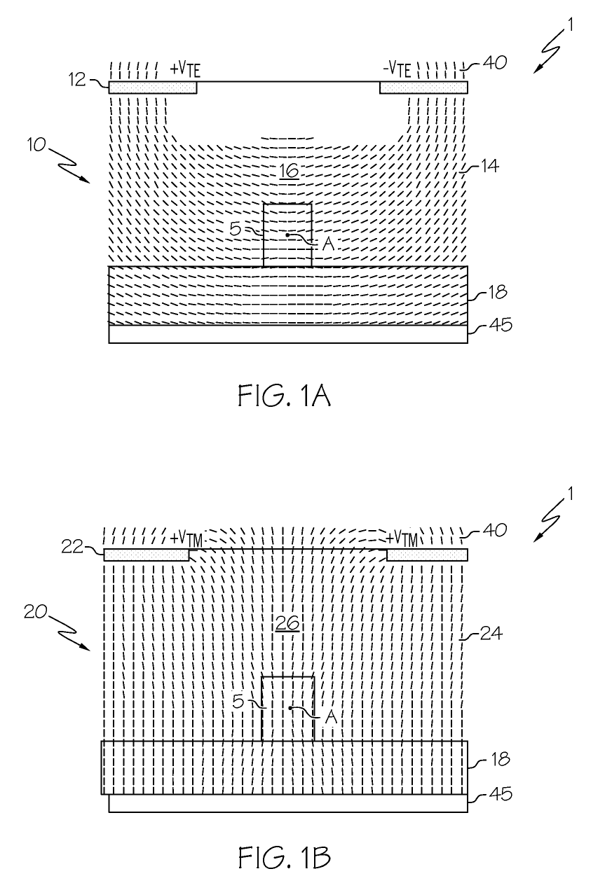

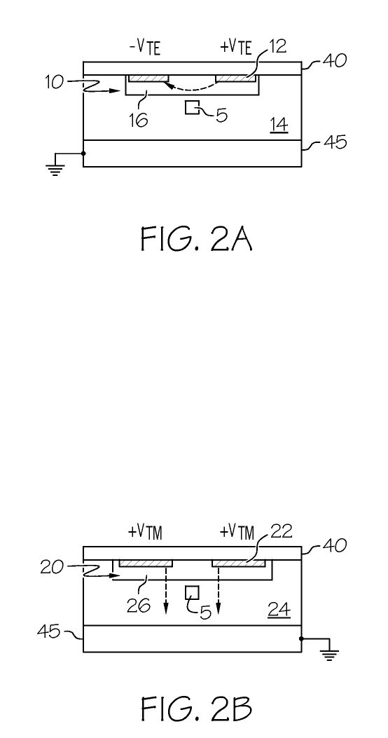

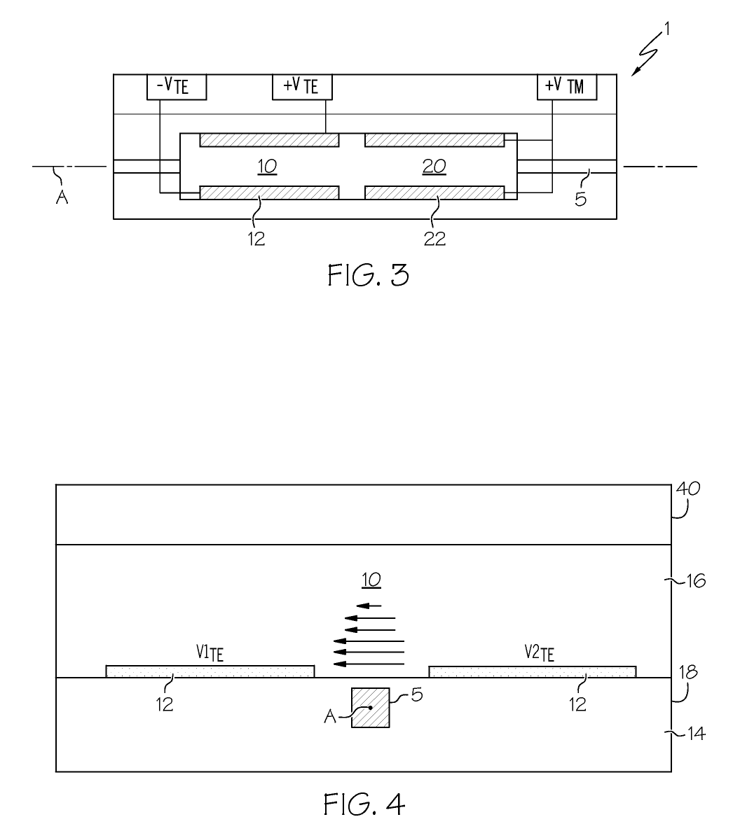

An optical waveguide structure 1 according to one embodiment of the present invention is illustrated in FIGS. 1-3. Referring initially to FIG. 3, the optical waveguide structure 1 comprises a waveguide core 5 and first and second electrooptic functional regions 10, 20. Components of the first electrooptic functional region 10 are illustrated with specificity in FIGS. 1A and 2A while components of the second electrooptic functional region 20 are illustrated with specificity in FIGS. 1B and 2B. As is illustrated in FIGS. 1A and 2A, the first electrooptic functional region 10 comprises a first set of control electrodes 12, a cladding region 14, and an electrooptic region 16. As is illustrated in FIGS. 1B and 2B, the second electrooptic functional region 20 comprises a second set of control electrodes 22, a cladding region 24, and an electrooptic region 26. For the purposes of defining and describing the present invention, it is noted that the first and second electrooptic functional regions 10, 20 are identified as “first” and “second” for ease of illustration only. Either region could be positioned first or second along the path of optical propagation.

For the purposes of describing and defining the present invention, it is noted that an electrooptic functional region is a region of an optical waveguide structure where application of an electrical control signal to the region alters the characteristics of an optical signal propagating along an optical axis defined in the waveguide structure to a significantly greater extent than in non-electrooptic regions of the structure. For example, electrooptic functional regions according to the present invention may comprise an electrooptic polymer configured to define an index of refraction that varies under application of a suitable electric field generated by control electrodes. Such a polymer may comprise a poled or un-poled electrooptic polymer dominated by the Pockels Effect, the Kerr Effect, or some other electrooptic effect. These effects and the various structures and materials suitable for their creation and use are described in detail in the context of waveguide devices in the following published and issued patent documents, the disclosures of which are incorporated herein by reference: U.S. Pat. Nos. 6,931,164 for Waveguide Devices Incorporating Kerr-Based and Other Similar Optically Functional Mediums, 6,610,219 for Functional Materials for use in Optical Systems, 6,687,425 for Waveguides and Devices Incorporating Optically Functional Cladding Regions, and 6,853,758 for Scheme for Controlling Polarization in Waveguides; and U.S. PG Pub. Nos. 2004/0184694 A1 for Electrooptic Modulators and Waveguide Devices Incorporating the Same and 2004/0131303 A1 for Embedded Electrode Integrated Optical Devices and Methods of Fabrication. Further, it is noted that, various teachings regarding materials and structures suitable for generating the Pockels Effect, the Kerr Effect, and other electrooptic effects in an optical waveguide structure are represented in the patent literature as a whole, particularly those patent documents in the waveguide art assigned to Optimer Photonics Inc. or naming Richard W. Ridgway, Steven M. Risser; Vincent McGinniss, and/or David W. Nippa as inventors.

A controller can be configured to provide a TE control voltage, illustrated as V_{TE} in FIGS. 1-3, to the first set of control electrodes 12 and a TM control voltage, illustrated as V_{TM} in FIGS. 1-3, to the second set of control electrodes 22. The TE control voltage is provided independent of the TM control voltage to provide for independent alteration of optical signals propagating through the first and second electrooptic functional regions 10, 20. In addition, the optical waveguide structure 1 further comprises a silicon ground plane 45 and a silica wafer substrate 18 over which the waveguide core 5, the cladding regions 14, 24, the electrooptic regions 16, 26, and the first and second sets of control electrodes 12, 22 are formed. The silicon ground plane 45 can be held at ground or at an electric potential biased from ground. For the purposes of defining and describing the present invention, it is noted that the term “over” contemplates the presence of intervening layers between two layers or regions. For example, referring to FIGS. 1A and 1B, it is noted that the waveguide core 5 can be properly described as being formed “over” the silicon ground plane 45, even though the substrate layer 18 is an intervening layer between the core 5 and the ground plane 45.

As is illustrated in FIGS. 1A and 2A, in operation, the TE control voltage is configured to generate a potential difference between the respective electrodes of the first set of control electrodes 12. The potential difference generated in this manner is of sufficient magnitude to dominate the electric field profile defined in the first electrooptic functional region 10. A representative electric field profile of this nature is illustrated in FIGS. 1A and 2A, where the control electrodes 12 are positioned symmetrically above the waveguide core 5. The representative field lines presented in detail in FIG. 1A and, to a lesser degree of specificity, in FIG. 2A, show the direction of the electric field. In the vicinity of the waveguide core 5, the electric field is almost completely horizontal. Assuming the cladding material has a positive dielectric anisotropy, the refractive index along the field will be higher than that orthogonal to the field. Calculation of the effective refractive index for modes with different polarizations will show the slow axis, i.e., the axis representing a large refractive index, is in the horizontal direction. Accordingly, TE polarized light will be most affected by the change in refractive index caused by the application of the TE control voltage in the first electrooptic functional region 10.

Similarly, referring to FIGS. 1B and 2B, the TM control voltage is configured to generate a potential difference between the silicon ground plane 45 and the electrodes of the second set of control electrodes 22 such that the potential difference is of sufficient magnitude to dominate the electric field profile defined in the second electrooptic functional region. Both top electrodes are held at a constant voltage and the silicon substrate is either grounded or held at a suitable electrical bias. A representative electric field profile of this nature is illustrated in FIGS. 1B and 2B, where the control electrodes 22 are positioned symmetrically above the waveguide core 5. In the vicinity of the waveguide core 5, the electric field is almost completely vertical. Calculation of the effective refractive index for modes with different polarizations will show the slow axis, i.e., the axis representing a large refractive index, is in the vertical direction. Accordingly, TM polarized light will be most affected by the change in refractive index caused by the application of the TM control voltage in the second electrooptic functional region 20.

Thus, the TE control voltage and the first electrooptic functional region 10 can be configured to alter a TE polarization mode of an optical signal propagating along the waveguide core 50 through the first electrooptic functional region 10 to a substantially greater extent than a TM polarization mode of the optical signal. Similarly, the TM control voltage and the second electrooptic functional region 20 can be configured to alter a TM polarization mode of an optical signal propagating along the waveguide core through the second electrooptic functional region to a substantially greater extent than a TE polarization mode of the optical signal. By arranging the optical waveguide structure 1 in the manner illustrated in FIG. 3 and controlling the TE and TM control voltages on each set of electrodes 12, 22, it is possible to have the device perform in the same manner for both TE and TM polarized light, thus exhibiting polarization independent performance with an electrooptic material.

Referring to FIGS. 2A and 2B, it is noted that the respective cladding regions 14, 24 may include wells that accommodate the electrooptic material 16, 26. This feature of the present invention is not required but can be particularly advantageous where the electrooptic material is not dimensionally stable, i.e., tends to flow under pressure or under its own weight. To ease device fabrication, the first and second sets of control electrodes 12, 22 can be positioned in these respective wells.

Referring to the embodiment of the present invention illustrated in FIGS. 1-3, it is noted that the waveguide core 5, the respective cladding regions 14, 24, the respective electrooptic regions 16, 26, and the first and second sets of control electrodes 12, 22 define a substantially constant cross-sectional progression along the optical axis A of the waveguide structure through the first and second electrooptic functional regions 10, 20. As a result, the structure according to this aspect of the present invention can be fabricated in a manner that is substantially less complex than would have been expected for a device configured for polarization independent performance. For the purposes of defining and describing the present invention, it is noted that a substantially constant cross-sectional progression is a physical configuration where the respective cross sections of a physical device along a given path are substantially identical irrespective of where along the path the respective cross sections are taken. As can be appreciated from FIG. 3, the device illustrated therein defines substantially identical cross sections only where the electrode sets are present in the cross section. Nevertheless, for the purposes of defining and describing the present invention, such a configuration is deemed to define a substantially constant cross-sectional progression because the electrodes are present along a substantial majority of the path length and because the cross sections taken therein represent substantially identical configurations.

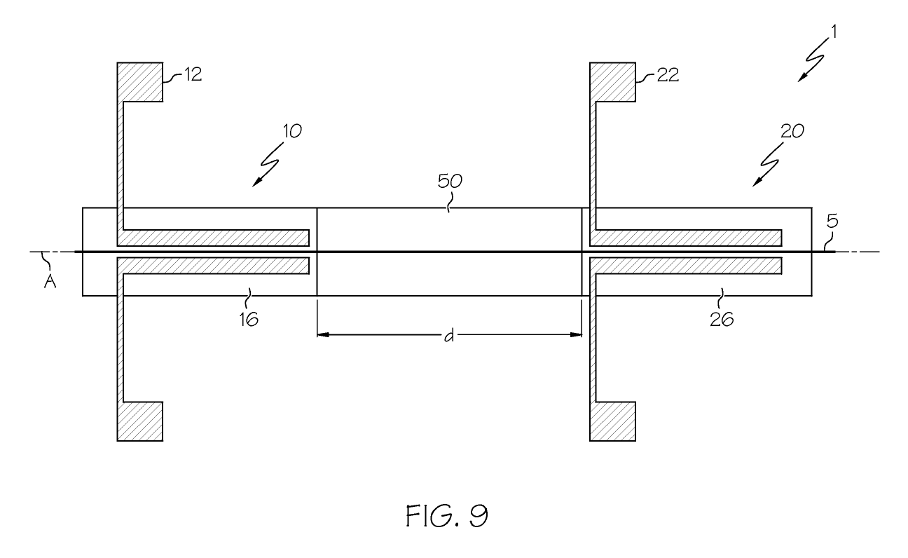

As may be gleaned from the configurations of FIGS. 1-3 and the additional waveguide structure configurations described below, the waveguide core 5 can be positioned in any of a variety of configurations, including: (i) a configuration where the core 5 lies entirely within a cladding layer defining the cladding region 14, 24 so as to be spaced from an electrooptic layer defining the electrooptic region 16, 26 by a portion of the cladding layer (see, e.g., FIGS. 2A, 2B, 4, and 5); (ii) a configuration where the core 5 lies within the cladding layer, abutting the electrooptic layer (see, e.g., FIG. 7); (iii) a configuration where the core 5 lies within the cladding layer and the electrooptic layer; (iv) a configuration where the core (5) lies within the electrooptic layer abutting the cladding layer (see, e.g., FIG. 8); or (v) a configuration where the core 5 lies entirely within the electrooptic layer so as to be spaced from the cladding layer by a portion of the electrooptic layer.

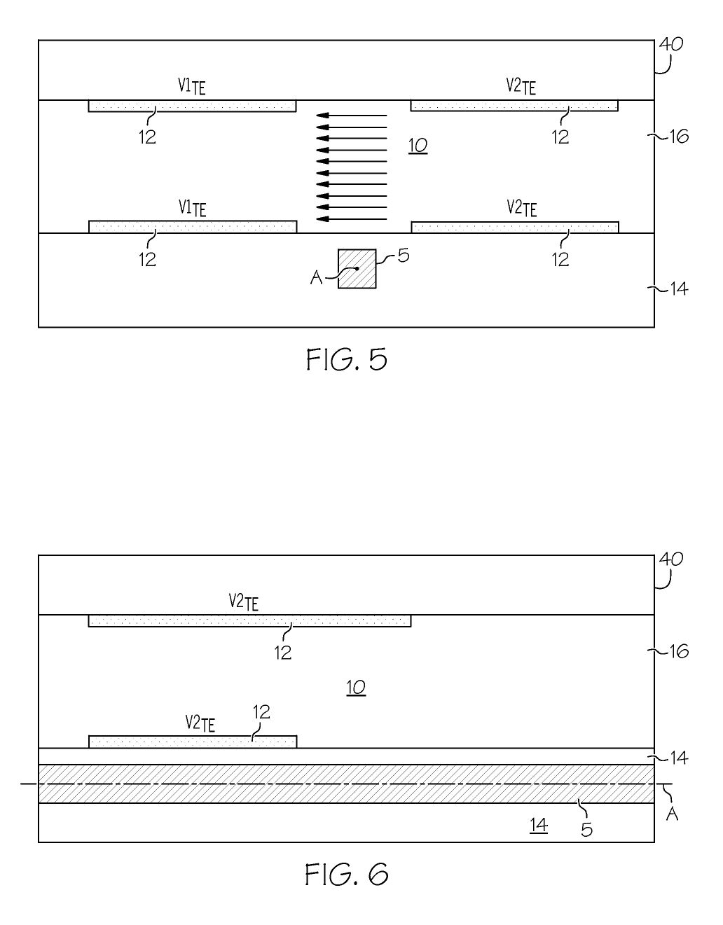

Referring now to FIGS. 4-6, a variety of alternative electrode configurations for use in electrooptic functional regions 10 configured to alter the TE polarization mode of an optical signal propagating along a waveguide core 5 are illustrated. Specifically, in FIG. 4, the optical waveguide structure 1 comprises a substrate 18 that serves as a cladding for the waveguide core 5. Although the substrate 18 can take a variety of forms suitable for this purpose, according to one contemplated embodiment, it comprises a silica layer grown or deposited on a silicon wafer. The control electrodes are generally centered about the waveguide core 5 and define a substantially coplanar configuration. The TE control voltage, illustrated as V1_{TE} and V2_{TE} in FIG. 4, is configured to generate a potential difference between the coplanar electrodes 12 that dominates the electric field profile defined in the electrooptic functional region 10. In the case of a Kerr-based electrooptic functional region, as voltage across the electrodes 12 is increased, the EO material orients to provide an increase in refractive index in a localized region above the waveguide core 5. The increased index causes light to couple into the EO polymer and away from the waveguide core 5. This results in optical attenuation of the TE mode of the optical signal because, as is illustrated by the directional arrows presented in the functional region of FIG. 4, the electric field is almost completely horizontal in the vicinity of the waveguide core 5. Accordingly, TE polarized light will be most affected by the change in refractive index caused by the application of the TE control voltage.

If the increased index region described with reference to FIG. 4 is concentrated closely to the waveguide core 5 it may not allow light to depart sufficiently far from the waveguide core 5 to provide the desired effect. In fact, the altered portion of the optical signal can recouple into the waveguide core 5 and act similar to a directional coupler. Where this recoupling is not desired, it may be preferable to utilize the electrode configuration illustrated in FIG. 5, where the illustrated control electrodes 12 define a substantially bi-planar configuration. In the biplanar configuration, a second set of control electrodes 12 are secured to a cover plate 40 positioned over the electrooptic region 10 in a manner disposing the electrodes 12 at least partially in an electrooptic material of the electrooptic regions 10. The alternative electrode configuration illustrated in FIG. 5 is designed to provide a vertically expanded region of electric field lines that causes an index increase that primarily influences TE polarized light. As the light couples vertically, it is no longer as closely confined to a region near the waveguide core 5 and can more freely exit the waveguide region. Therefore, optical attenuation is increased as light is more successfully extracted from the waveguide core 5.

For the purposes of defining and describing the present invention, it is noted that coplanar electrodes comprises electrodes that are oriented generally along a common plane. Bi-planar electrodes comprise electrodes that are oriented along distinct planes that are generally parallel to but offset from each other in a given direction.

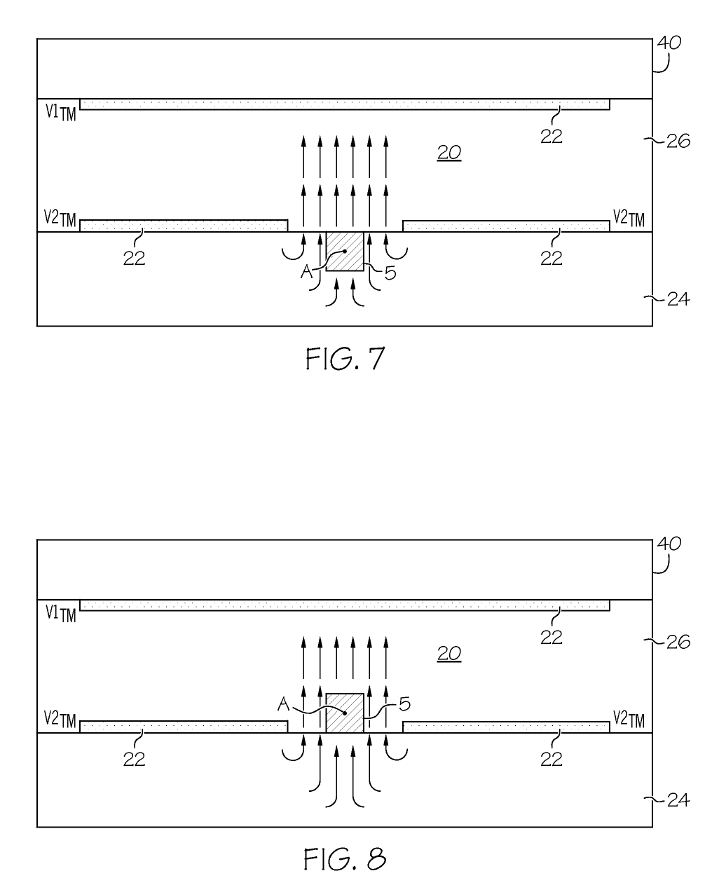

Referring now to FIG. 6, which is an illustration of an electrooptic functional region 10 similar to that of FIG. 5 but taken along the direction of propagation of the optical signal along the waveguide core 5, it is noted that the electrodes 12 secured to the cover plate 40 could be extended beyond the length of the substrate-based electrodes. This extension would provide a high index region farther above the core 5 to discourage light from reentering the core 5. Specifically, when the light in the polymer encounters the region below the extended electrode, it is further attracted away from the waveguide core 5, instead of coupling back into the waveguide core 5. In FIG. 6, the cladding region 14 surrounds the core in the manner illustrated in FIG. 5. However, it is noted that the relatively thin portion of the cladding region 14 need not extend between the core 5 and the electrooptic region 16 in the embodiments of FIGS. 5 and 6, or other similar embodiments disclosed herein.

Referring now to FIGS. 7 and 8, alternative electrode configurations for use in electrooptic functional regions 20 configured to alter the TM polarization mode of an optical signal propagating along a waveguide core 5 are illustrated. Specifically, FIGS. 7 and 8 illustrate alternative TM electrode configurations in the context of a single-waveguide variable optical attenuator. In FIG. 7, the control electrodes 22 define a substantially bi-planar configuration and the TM control voltage, illustrated as V1_{TM} and V2_{TM} in FIGS. 7 and 8, is configured to generate a potential difference between the bi-planar electrodes 22 in the manner illustrated (see the directional field indicator arrows in FIGS. 7 and 8). This configuration allows relatively easy patterning of the electrodes 22 adjacent to the waveguide core 5 because the surface on which the electrodes are formed is planar. When the TM control voltage is applied, the resulting electric field contour lines are primarily vertical in the vicinity of the waveguide core 5. As is noted above, fields of this nature primarily influence TM light in the EO planar waveguide devices 1. FIG. 8 illustrates an approach where the control electrodes 22 are placed adjacent to the core 5 on a non-planar surface. However, it is contemplated that this approach may be more challenging to fabricate.

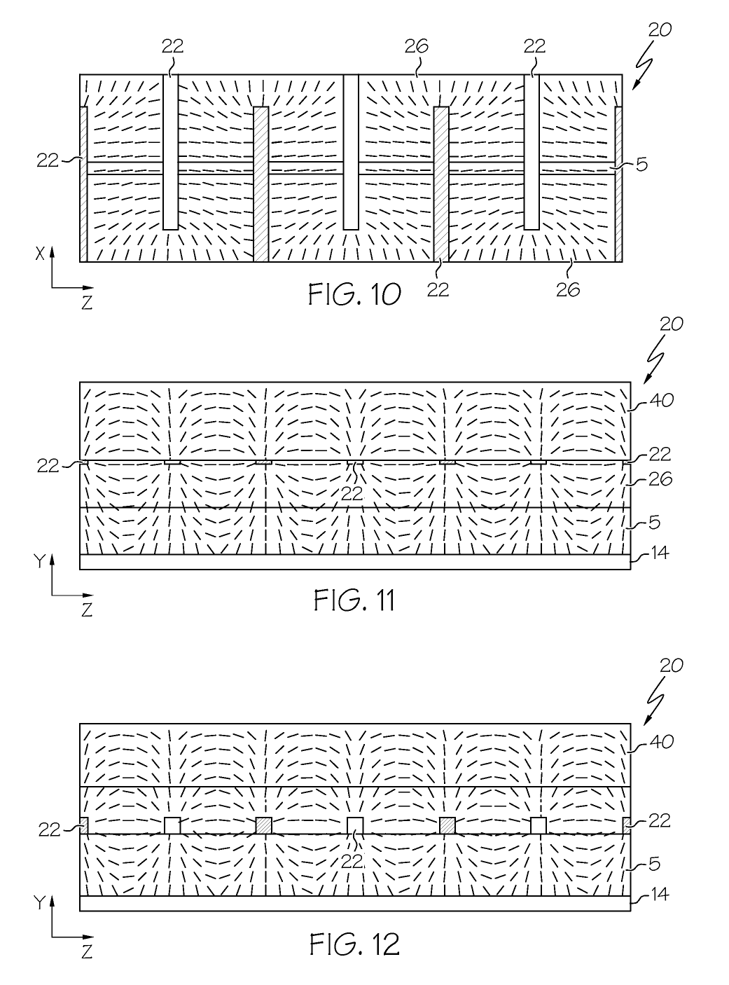

Referring to FIG. 9, it is noted that many embodiments disclosed herein utilize electrooptic functional regions 10, 20 that are spaced apart by a given distance d along the direction of optical propagation defined by the waveguide core 5 of the optical waveguide structure 1. The spaced electrooptic functional regions 10, 20 may serve to treat TE and TM polarized separately, as is described above with reference to FIG. 3, may merely be presented to provide sufficient attenuation of a given optical signal, or may be utilized for other purposes. Regardless of the purpose of the electrooptic functional regions 10, 20, the present inventors have recognized a need to prevent the recoupling of light back into the waveguide core 5 from the electrooptic region 16 of the first electrooptic functional region 10. Specifically, an increase in refractive index in a localized region above the waveguide core 5 will cause light to couple into the electrooptic region 16, away from the waveguide core 5. If the increased index region is concentrated closely to the waveguide core 5, it may not allow light to depart sufficiently far from the waveguide core 5 to provide the desired affect, e.g., attenuation. In fact, the light can recouple in to the waveguide core 5. If an electrode or set of electrodes is designed to influence the same polarization as the previous electrode region, it is particularly important that the light be sufficiently radiated from the waveguide core 5 to prevent recoupling.

According to the approach illustrated in FIG. 9, a material with a specially designed index of refraction is placed above the waveguide core 5 to encourage light to radiate farther from the core 5. More specifically, an anti-recoupling region 50 is defined between the first and second electrooptic functional regions 10, 20, and comprises an anti-recoupling material characterized by an index of refraction that is lower than that of the electrooptic region 16 in the first electrooptic functional region 10. The anti-recoupling material can be configured as a cladding for a portion of the waveguide core 5 between the first and second electrooptic functional regions and can extend a full or partial distance between the first and second electrooptic functional regions 10, 20. The anti-recoupling material could simply be the surrounding cladding material of the waveguide core 5 or another material, such as a low index polymer applied above the waveguide core 5. In addition, it is contemplated that the anti- recoupling region 50 need not be limited to use between two electrooptic functional regions 10, 20 and can be placed after an electrooptic functional region in a device employing only one electrooptic functional region. It is noted that the anti-recoupling measures described herein with reference to FIG. 9 are likely to be particularly well-suited for use in the context of a single-waveguide variable optical attenuator structure.

According to another contemplated embodiment of the present invention, it is noted that the anti-recoupling region 50 illustrated in FIG. 9 could comprise an inhomogeneous refractive index medium on or above the chip that would be configured to disrupt the optical field in the region 50 and discourage recoupling into the waveguide core.

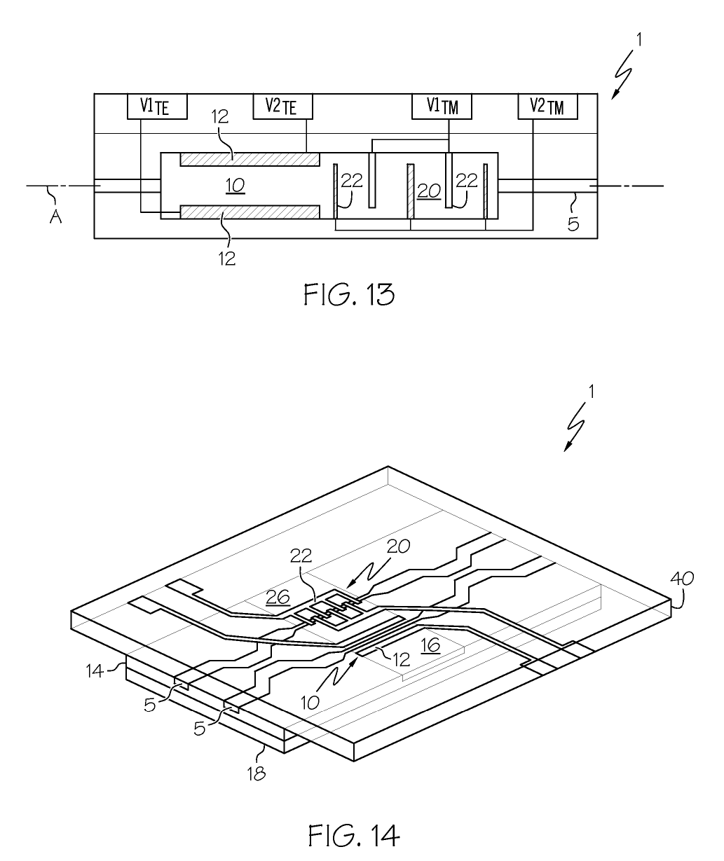

Turning now to FIGS. 10-14, an alternative means for configuring an electrooptic functional region to treat the TE and TM polarization modes of an optical signal is presented. Specifically, referring to FIGS. 10 and 11, where FIG. 10 is a top view of the waveguide structure and FIG. 11 is a side view of the structure through the waveguide core 5, an electrooptic functional region 20 is illustrated where a set of control electrodes 22 are spaced along a direction of optical propagation defined by the waveguide core 5 and extend across the waveguide core 5 in an interleaved configuration. The electrode configuration illustrated in FIG. 12 differs from that illustrated in FIGS. 10 and 11 in that the control electrodes 22 are not supported by the cover plate 40. Rather, the control electrodes are formed on or secured to the silica-based substrate in which the waveguide core 5 is defined. Because of the location of the electrodes 22 in close proximity to the core 5, the configuration illustrated in FIG. 12 is best suited for applications where it is desired to attenuate an optical signal, while the configuration illustrated in FIGS. 10 and 11 is more adaptable to waveguide structures operating in either a phase change or loss change mode.

The electric field generated by the control electrodes illustrated in FIGS. 10-12 can be calculated and used to calculate the changes in the refractive index tensor and the difference in index between TE and TM polarized light in the electrooptic functional region 20. In the illustrated electrode arrangement, the electric field is in the Y-Z plane. The results of the calculations show that, for electrooptic regions configured to generate an electric field in the Y-Z plane, the refractive index increases almost equally in the y and z directions, and the refractive index has a large decrease in the x direction. In contrast, for electrooptic regions such as those illustrated in FIGS. 1A and 2A, the generated electric field resides primarily in the X-Y plane and the refractive index decreases almost equally as much in the y and z directions, with a large increase in the x direction. As a result, the electrode configurations of FIGS. 10-12 can be utilized to configure the novel optical waveguide structure 1 illustrated in FIGS. 13 and 14, where TE and TM modes of polarization of the optical signal are altered to substantially equivalent or intentionally disparate degrees.

In the configuration of FIG. 13, the optical waveguide structure 1 comprises a first electrooptic functional region 10 that includes a set of control electrodes 12 that extend along the direction of optical propagation defined by the waveguide core 5, on opposite sides of the waveguide core 5. The waveguide structure 1 further comprises a second electrooptic functional region 20 that includes a set of control electrodes 22 that are spaced along the direction of optical propagation, as is described above with reference to FIGS. 10-12. The waveguide core 5 comprises a single path waveguide core 5 and the first and second sets of control electrodes 12, 22 are positioned in succession along the single path.

The first set of control electrodes 12 is configured to generate an electric field that is oriented in a plane that is substantially orthogonal to the direction of optical propagation defined by the waveguide core 5. In contrast, the second set of control electrodes 22 is configured to generate an electric field that is oriented in a plane that is substantially parallel to the direction of optical propagation. As a result, a controller can be configured to provide TE and TM control voltages such that the TE and TM modes of polarization of the optical signal are altered to substantially equivalent degrees upon propagation through the first and second electrooptic functional regions 10, 20. More specifically, the TE and TM control voltages can be determined, at least in part, according to the following relation:
Δn_{TE}_{₁}+Δn_{TE}_{₂}x²=Δn_{TM}_{₁}+Δn_{TM}_{₂}x²
where Δn_{TE}_{₁} represents the change in index of refraction for TE polarized light in the first electrooptic functional region, as induced by the TE control voltage, Δn_{TM}_{₁} represents the change in index of refraction for TM polarized light in the first electrooptic functional region, as induced by the TE control voltage, Δn_{TE}_{₂} represents the change in index of refraction for TE polarized light in the second electrooptic functional region, as induced by the TM control voltage, Δn_{TM}_{₂} represents the change in index of refraction for TM polarized light in the second electrooptic functional region, as induced by the TM control voltage, and x represents the TM/TE control voltage ratio.

As is noted above, the controller can also be configured to provide TE and TM control voltages such that only one of the polarization modes is subject to alteration while the remaining mode of polarization is altered to a negligible extent. Specifically, it is contemplated that the TE and TM control voltages can be determined, at least in part, according to one of the following relations:
Δn_{TM}_{₁}+Δn_{TM}_{₂}x²=0, for negligible alteration of the TM polarization mode; and
Δn_{TE}_{₁}+Δn _{TE}_{₂}x²=0, for negligible alteration of the TM polarization mode,
where Δn_{TE}_{₁} represents the change in index of refraction for TE polarized light in the first electrooptic functional region, as induced by the TE control voltage, Δn_{TM}_{₁} represents the change in index of refraction for TM polarized light in the first electrooptic functional region, as induced by the TE control voltage, Δn_{TE}_{₂} represents the change in index of refraction for TE polarized light in the second electrooptic functional region, as induced by the TM control voltage, Δn_{TM}_{₂} represents the change in index of refraction for TM polarized light in the second electrooptic functional region, as induced by the TM control voltage, and x represents the TM/TE control voltage ratio.

The structure illustrated in FIG. 13 utilized the combination of two electrode patterns on a single arm of a waveguide structure, e.g., a Mach-Zehnder interferometer (MZI), to fabricate a device with specified polarization-dependent or independent behavior. In contrast, the waveguide structure 1 illustrated in FIG. 14 utilizes two distinct electrode patterns on the two separate arms of a MZI type device to control the polarization-dependent behavior of the MZI device. Polarization independent performance can be achieved, assuming substantially equal electrode lengths, in a MZI type device by placing a single electrode on each arm of the device and applying different voltages to the two electrode patterns. The condition for polarization independent performance is that the index change for each polarization should be equal in magnitude. More specifically, the TE and TM control voltages can be determined, at least in part, according to the following relation:

$$\vert Δ {n}_{{TE}_{1}} - Δ {n}_{{TE}_{2}} {x}^{2} \vert = \vert Δ {n}_{{TM}_{1}} - {Δ}_{{TM}_{2}} {x}^{2} \vert$$

The difference between this equation and the previous is that the phase difference between the two arms is the relevant quantity, not the total phase change along the single arm.

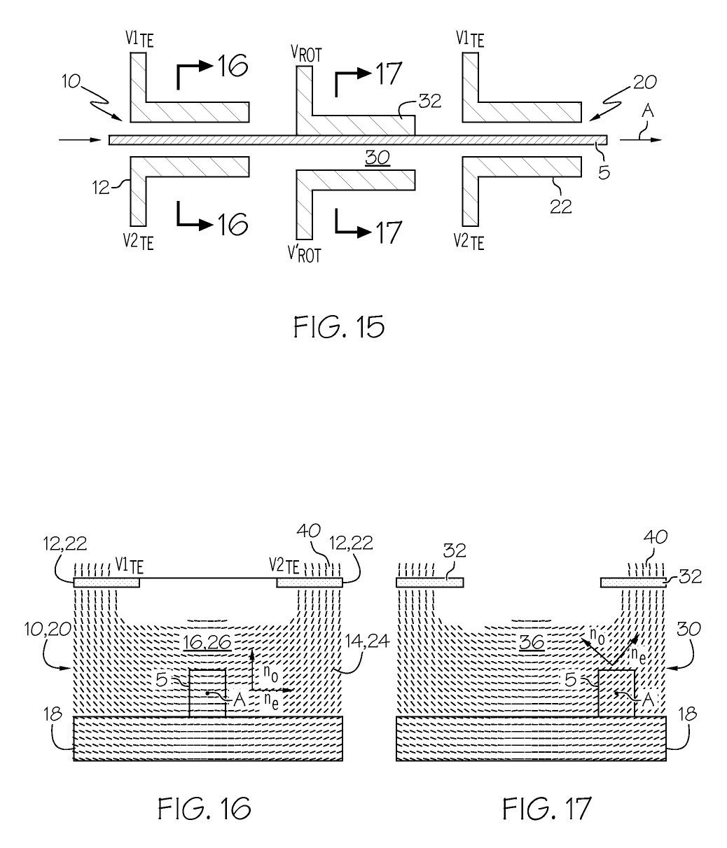

In the embodiment of the present invention illustrated in FIGS. 15-17, an additionally contemplated optical waveguide structure according to the present invention comprises first, second, and third electrooptic functional regions 10, 20, 30. As is the case in many of the other embodiments described herein, each electrooptic functional region 10, 20, 30 comprises a set of control electrodes 12, 22, 32 and electrooptic regions 16, 26, 36. The third electrooptic functional region 30 is defined between the first and second electrooptic functional regions 10, 20 along the path of optical propagation extending from the first electrooptic functional region 10 to the second electrooptic functional region 20. A controller can be configured to provide a first control voltage, illustrated as V1_{TE} and V2_{TE} in FIG. 15, to the first set of control electrodes 12, a second control voltage, also illustrated as V1_{TE} and V2_{TE} in FIG. 15, to the second set of control electrodes 22, and a polarization control voltage, illustrated as V_{ROT} and V′_{ROT} in FIG. 15, to the third set of control electrodes 32.

As is illustrated in FIGS. 15-17, the waveguide core 5 and the first and second sets of control electrodes 12, 22 define a symmetric configuration relative to a plane oriented along the optical axis, orthogonal to a plane defined by the control electrodes 12, 22. In contrast, the waveguide core 5 and the third set of control electrodes 32 define an asymmetric configuration relative to the same plane. As is illustrated with particularity in FIG. 17, the application of an electric field by control electrodes offset above a waveguide by a proper amount can cause the primary optical axis of the guided wave to be at a 45° angle between the TE and TM directions. Accordingly, the first set of control electrodes 12, which are placed symmetrically above the waveguide core 5, can be used to primarily alter the TE component of the incident optical signal. The signal then enters the third electrooptic functional region 30, where the electrodes are offset above the waveguide core 5 by an amount that will cause the primary optical axis of the guided wave to be at a 45° angle between the TE and TM directions, yielding an effective half-wave plate, flipping the TE and TM components of the optical signal. The optical signal then enters the second electrooptic functional region 20, which is substantially identical to the first region 10. In the second region 20, the TE polarization, which originally was TM, is the polarization that experiences the larger electrooptic response. Thus, the total response for each polarization mode is substantially equivalent because the initial TE and TM polarizations have both gone through an electrode region where they experience the larger electrooptic response. Thus, by utilizing the electrooptic effect generated in the third electrooptic functional region 30 to form a half-wave plate, the illustrated device provides polarization-independent response from an electrode configuration which inherently is polarization-dependent. As an aside, it is noted that the amount of the phase shift can be controlled by the magnitude of the voltage applied across the electrodes, thus creating a controllable half-wave plate in the region where the electric field is applied.

The specific values suitable for the variety of control voltages described herein will vary widely depending upon the specific waveguide structure at issue and the preferred operational characteristics of that structure. Guidance regarding values of such voltages may be gleaned from the collection of teachings noted above and through routine experimentation. A number of control voltages have been identified herein with reference to specific symbols and subscripts and it is noted that no inferences regarding voltage values or relative polarities are intended to be drawn from the use of those subscripts. For example, in FIG. 15, V1_{TE} and V2_{TE} are used to identify the voltages associated with the first and second sets of electrodes 12, 22 but it does not necessarily follow that the voltage V1_{TE}, as applied to the first set of electrodes 12, is equal to the voltage V1_{TE}, as applied to the second set of electrodes 12. In addition, it is noted that the subscripts “TE” and “TM” are merely presented herein to convey the understanding that the associated voltage is selected to affect either the TE or TM mode of polarization to a greater extent than the other. For example, referring to FIGS. 1A and 1B, it is noted that the voltages applied to the electrodes in FIG. 1A are selected to generate an electric field that will affect the TE mode of polarization more than the TM mode while the voltages applied to the electrodes in FIG. 1B are selected to generate an electric field that will affect the TM mode of polarization more than the TE mode. Finally, it is noted that nothing in the present specification should be taken to exclude electrical ground as an available candidate for a specific control voltage value.

For the purposes of defining and describing the present invention, it is noted that the wavelength of “light” or an “optical signal” is not limited to any particular wavelength or portion of the electromagnetic spectrum. Rather, “light” and “optical signals,” which terms are used interchangeably throughout the present specification and are not intended to cover distinct sets of subject matter, are defined herein to cover any wavelength of electromagnetic radiation capable of propagating in an optical waveguide. For example, light or optical signals in the visible and infrared portions of the electromagnetic spectrum are both capable of propagating in an optical waveguide. An optical waveguide may comprise any suitable signal propagating structure. Examples of optical waveguides include, but are not limited to, optical fibers, slab waveguides, and thin-films used, for example, in integrated optical circuits.

Although the present invention has been described in the context of electrooptic materials in the cladding region of a waveguide, it is contemplated that many of the embodiments described herein are also applicable for functional electrooptic waveguide cores-with or without functional claddings. It is further contemplated that, in some embodiments of the present invention, it may be preferable to configure the waveguide as a periodically segmented waveguide structure comprising a series of waveguide segments formed of a suitable waveguide core material interspersed between respective segments of an optically functional material along the direction of propagation of the optical signal. Further, some embodiments of the present invention have been illustrated with reference to functional regions including poled electrooptic portions. However, it is noted that the concepts of the present invention are equally applicable to devices where the electrooptic portions of the functional regions are not characterized by a predetermined poling.

For the purposes of describing and defining the present invention, it is noted that TE and TM polarized light represent two independent electromagnetic modes of an optical signal. The electromagnetic field distribution is referred to as the transverse electric (TE) mode where the electric field of the optical signal is perpendicular to the plane extending along the primary axis of propagation of the waveguide core. The electromagnetic field distribution is referred to as the transverse magnetic (TM) mode where the magnetic field of the optical signal is perpendicular to the plane extending along the primary axis of propagation of the waveguide core. It is also noted that in a channel waveguide of the illustrated type, the propagating modes are not purely TE or TM polarized. Rather, the modes are typically more predominantly one or the other and are commonly so designated. Accordingly, a TE polarized mode may merely comprise a distribution where the electric field component parallel to the plane of propagation is the largest component of the signal. Similarly, a TM polarized mode may merely comprise a distribution where the magnetic field component parallel to the plane of propagation is the largest component of the signal.

For the purposes of defining and describing the present invention, it is noted that “alteration” of a particular polarization mode of an optical signal contemplates, among other things, amplitude attenuation, phase delay, polarization rotation, signal re-direction, velocity alteration, or the alterations of some other transmission characteristic of an optical signal propagating along the waveguide core. Accordingly, by way of illustration and not limitation, it is contemplated that optical waveguide structures according to the present invention can be configured as optical interferometers, optical phase delay structures, variable optical attenuators, and combinations thereof.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. For example, although electrooptic functional regions according to specific embodiments of the present invention can be selected such that the variation of the index of refraction is dominated by an electrooptic response resulting from the Kerr Effect because Kerr Effect mediums can, in specific configurations, have the capacity for significantly higher changes in index of refraction than mediums dominated by the Pockels Effect, it is understood that electrooptic region may be dominated by the Pockels Effect, the Kerr Effect, or some other electrooptic effect.

What is claimed is:

1. An optical waveguide structure comprising a waveguide core, first and second electrooptic functional regions, and a controller, wherein:
said first electrooptic functional region comprises a first set of control electrodes, a cladding region, and an electrooptic region;
said second electrooptic functional region comprises a second set of control electrodes, a cladding region, and an electrooptic region;
said controller is configured to provide a TE control voltage to said first set of control electrodes and a TM control voltage to said second set of control electrodes;
said TE control voltage is provided independent of said TM control voltage;
said TE control voltage and said first electrooptic functional region are configured to alter a TE polarization mode of an optical signal propagating along said waveguide core through said first electrooptic functional region to a substantially greater extent than a TM polarization mode of said optical signal;
said TM control voltage and said second electrooptic functional region are configured to alter a TM polarization mode of an optical signal propagating along said waveguide core through said second electrooptic functional region to a substantially greater extent than a TE polarization mode of said optical signal;
said optical waveguide structure further comprises at least one silicon ground plane over which said waveguide core, said cladding region, said electrooptic region, and said first and second sets of control electrodes are formed;
said TE control voltage is configured to generate a potential difference between electrodes of said first set of control electrodes, said potential difference being of sufficient magnitude to dominate an electric field profile defined in said first electrooptic functional region; and
said TM control voltage is configured to generate a potential difference between said silicon ground plane and electrodes of said second set of control electrodes, said potential difference being of sufficient magnitude to dominate an electric field profile defined in said second electrooptic functional region.

2. An optical waveguide structure as claimed in claim 1 wherein said TE control voltage is further configured to generate respective potential differences between respective electrodes of said first set of control electrodes and said silicon ground plane, said respective potential differences being opposite in polarity.

3. An optical waveguide structure as claimed in claim 1 wherein said potential difference generated between said silicon ground plane and respective electrodes of said second set of control electrodes is of common polarity.

4. An optical waveguide structure comprising a waveguide core, first and second electrooptic functional regions, and a controller, wherein:
said first electrooptic functional region comprises a first set of control electrodes, a cladding region, and an electrooptic region;
said second electrooptic functional region comprises a second set of control electrodes, a cladding region, and an electrooptic region;
said controller is configured to provide a TE control voltage to said first set of control electrodes and a TM control voltage to said second set of control electrodes;
said TE control voltage is provided independent of said TM control voltage;
said TE control voltage and said first electrooptic functional region are configured to alter a TE polarization mode of an optical signal propagating along said waveguide core through said first electrooptic functional region to a substantially greater extent than a TM polarization mode of said optical signal;
said TM control voltage and said second electrooptic functional region are configured to alter a TM polarization mode of an optical signal propagating along said waveguide core through said second electrooptic functional region to a substantially greater extent than a TE polarization mode of said optical signal;
said first set of control electrodes defines a substantially bi-planar configuration comprising a pair of upper electrodes arranged on opposite sides of said waveguide core and a pair of lower electrodes arranged on opposite sides of said waveguide core; and
said upper electrodes extend further along a direction of propagation of said optical signal than do said lower electrodes.

5. An optical waveguide structure comprising a waveguide core, first and second electrooptic functional regions, and a controller, wherein:
said first electrooptic functional region comprises a first set of control electrodes, a cladding region, and a first electrooptic region;
said first electrooptic region comprises a poled or un-poled electrooptic polymer dominated by the Pockels Effect, the Kerr Effect, or some other electrooptic effect and configured to define an index of refraction that varies under application of a suitable electric field generated by said first set of control electrodes;
said second electrooptic functional region comprises a second set of control electrodes, a cladding region, and a second electrooptic region;
said second electrooptic region comprises a poled or un-poled electrooptic polymer dominated by the Pockels Effect, the Kerr Effect, or some other electrooptic effect and configured to define an index of refraction that varies under application of a suitable electric field generated by said second set of control electrodes;
said controller is configured to provide a TE control voltage to said first set of control electrodes and a TM control voltage to said second set of control electrodes;
said TE control voltage is provided independent of said TM control voltage;
said TE control voltage and said first electrooptic functional region are configured to alter a TE polarization mode of an optical signal propagating along said waveguide core through said first electrooptic functional region to a substantially greater extent than a TM polarization mode of said optical signal;
said TM control voltage and said second electrooptic functional region are configured to alter a TM polarization mode of an optical signal propagating along said waveguide core through said second electrooptic functional region to a substantially greater extent than a TE polarization mode of said optical signal;
said first set of control electrodes extend along a direction of optical propagation defined by said waveguide core, on opposite sides of said waveguide core; and
said second set of control electrodes are spaced along a direction of optical propagation defined by said waveguide core, extending across said waveguide core.

6. An optical waveguide structure as claimed in claim 5 wherein:
said waveguide core comprises a single path waveguide core and said first and second sets of control electrodes are positioned in succession along said single path; or
said waveguide core comprises first and second waveguide arms and said first and second sets of control electrodes are positioned along separate ones of said waveguide arms.

7. An optical waveguide structure as claimed in claim 1 wherein said first and second sets of control electrodes define a substantially constant cross-sectional progression along an optical axis of said waveguide structure through said first and second electrooptic functional regions of said waveguide structure.

8. An optical waveguide structure as claimed in claim 1 wherein:
said first set of control electrodes in said first electrooptic functional region are configured to generate an electric field that is oriented in a plane that is substantially orthogonal to a direction of optical propagation defined by said waveguide core; and
said second set of control electrodes in said second electrooptic functional region are configured to generate an electric field that is oriented in a plane that is substantially parallel to said direction of optical propagation.

9. An optical waveguide structure as claimed in claim 8 wherein:
said controller is configured to provide said TE and TM control voltages such that said TE and TM modes of polarization of said optical signal are altered to substantially equivalent degrees upon propagation through said first and second electrooptic functional regions; and
said TE and TM control voltages are determined, at least in part, according to the following relation:
Δn_{TE}_{₁}+Δn_{TE}_{₂}x²=Δn_{TM}_{₁}+Δn_{TM}_{₂}x²
where Δn_{TE}_{₁} represents the change in index of refraction for TE polarized light in said first electrooptic functional region, as induced by said TE control voltage, Δn_{TM}_{₁} represents the change in index of refraction for TM polarized light in said first electrooptic functional region, as induced by said TE control voltage, Δn_{TE}_{₂} represents the change in index of refraction for TE polarized light in said second electrooptic functional region, as induced by said TM control voltage, Δn_{TM}_{₂} represents the change in index of refraction for TM polarized light in said second electrooptic functional region, as induced by said TM control voltage, and x represents the TM/TE control voltage ratio.

10. An optical waveguide structure as claimed in claim 8 wherein:
said controller is configured to provide said TE and TM control voltages such that said TE and TM modes of polarization of said optical signal are altered to substantially equivalent degrees upon propagation through said first and second electrooptic functional regions; and
said TE and TM control voltages are determined, at least in part, according to the following relation:
$$\vert Δ {n}_{{TE}_{1}} - Δ {n}_{{TE}_{2}} {x}^{2} \vert = \vert Δ {n}_{{TM}_{1}} - {Δ}_{{TM}_{2}} {x}^{2} \vert$$
where Δn_{TE}_{₁} represents the change in index of refraction for TE polarized light in said first electrooptic functional region, as induced by said TE control voltage, Δn_{TM}_{₁} represents the change in index of refraction for TM polarized light in said first electrooptic functional region, as induced by said TE control voltage, Δn_{TE}_{₂} represents the change in index of refraction for TE polarized light in said second electrooptic functional region, as induced by said TM control voltage, Δn_{TM}_{₂} represents the change in index of refraction for TM polarized light in said second electrooptic functional region, as induced by said TM control voltage, and x represents the TM/TE control voltage ratio.

11. An optical waveguide structure as claimed in claim 8 wherein:
said controller is configured to provide said TE and TM control voltages such that one of said TE and TM modes of polarization of said optical signal is altered to a negligible extent, relative to the other of said polarization modes, upon propagation through said first and second electrooptic functional regions; and
said TE and TM control voltages are determined, at least in part, according to one of the following relations:
Δn_{TM}_{₁}+Δn_{TM}_{₂}x²=0, for negligible alteration of said TM polarization mode; and
Δn_{TE}+Δn_{TE}_{₂}x²=0, for negligible alteration of said TM polarization mode,
where Δn_{TE}_{₁} represents the change in index of refraction for TE polarized light in said first electrooptic functional region, as induced by said TE control voltage, Δn_{TM}₁ represents the change in index of refraction for TM polarized light in said first electrooptic functional region, as induced by said TE control voltage, Δn_{TE}_{₂} represents the change in index of refraction for TE polarized light in said second electrooptic functional region, as induced by said TM control voltage, Δn_{TM}_{₂} represents the change in index of refraction for TM polarized light in said second electrooptic functional region, as induced by said TM control voltage, and x represents the TM/TE control voltage ratio.

12. An optical waveguide structure comprising a waveguide core, first and second electrooptic functional regions, an anti-recoupling region, and a controller, wherein:
said first electrooptic functional region comprises a first set of control electrodes, a cladding region, and an electrooptic region;
said second electrooptic functional region comprises a second set of control electrodes, a cladding region, and an electrooptic region;
said controller is configured to provide a TE control voltage to said first set of control electrodes and a TM control voltage to said second set of control electrodes;
said TE control voltage is provided independent of said TM control voltage;
said TE control voltage and said first electrooptic functional region are configured to alter a TE polarization mode of an optical signal propagating along said waveguide core through said first electrooptic functional region to a substantially greater extent than a TM polarization mode of said optical signal;
said TM control voltage and said second electrooptic functional region are configured to alter a TM polarization mode of an optical signal propagating along said waveguide core through said second electrooptic functional region to a substantially greater extent than a TE polarization mode of said optical signal; and
said anti-recoupling region is defined at least partially between said first and second electrooptic functional regions and comprises (i) an anti-recoupling material characterized by an index of refraction that is lower than that of said electrooptic region in said first electrooptic functional region or (ii) an inhomogeneous refractive index medium configured to disrupt an optical field of said optical signal to an extent sufficient to discourage recoupling of said optical signal into said waveguide core.

13. An optical waveguide structure as claimed in claim 12 wherein an additional anti-recoupling region is defined following said second electrooptic functional region in a direction of propagation of said optical signal.

14. An optical waveguide structure comprising a waveguide core, first, second, and third electrooptic functional regions, and a controller, wherein:
said third electrooptic functional region is defined between said first and second electrooptic functional regions along a path of optical propagation extending from said first electrooptic functional region to said second electrooptic functional region;
said controller is configured to provide a first control voltage to said first electrooptic functional region, a second control voltage to said second electrooptic functional region, and a polarization control voltage to said third electrooptic functional region;
said first and second control voltages and said first and second electrooptic functional regions are configured to alter similarly oriented polarization modes of an optical signal propagating along said waveguide core; and
said polarization control voltage and said third electrooptic functional region are configured to reverse the respective magnitudes of TE and TM polarization modes of an optical signal propagating along said waveguide core through said third electrooptic functional region.

15. An optical waveguide structure as claimed in claim 14 wherein:
said first electrooptic functional region comprises a first set of control electrodes, a cladding region, and an electrooptic region;
said second electrooptic functional region comprises a second set of control electrodes, a cladding region, and an electrooptic region; and
said third electrooptic functional region comprises a third set of control electrodes, a cladding region, and an electrooptic region.

16. An optical waveguide structure as claimed in claim 15 wherein:
said waveguide core and said first set of control electrodes define a symmetric configuration relative to a plane oriented along said optical axis, orthogonal to a plane defined by said control electrodes;
said waveguide core and said second set of control electrodes define a symmetric configuration relative to a plane oriented along said optical axis, orthogonal to a plane defined by said control electrodes; and
said waveguide core and said third set of control electrodes define an asymmetric configuration relative to a plane oriented along said optical axis, orthogonal to a plane defined by said control electrodes.

17. An optical waveguide structure as claimed in claim 14 wherein said controller is configured to vary a magnitude of said first and second control voltages and said polarization control voltage to control a degree of phase shift imparted to TE and TM polarization modes of an optical signal propagation through said first, second, and third electrooptic functional regions.

18. An optical waveguide structure as claimed in claim 14 wherein said controller is configured such that said degree of phase shift imparted to said TE and TM polarization modes is substantially equivalent.

19. An optical waveguide structure as claimed in claim 1 wherein said optical waveguide structure is configured as an optical interferometer, an optical phase delay structure, a variable optical attenuator, or combinations thereof.

20. An optical waveguide structure as claimed in claim 5 wherein said optical waveguide structure is configured as an optical interferometer, an optical phase delay structure, a variable optical attenuator, or combinations thereof.
